(19) United States
(12) Patent Application Publication
(10) Pub. No.: US 2016/0074707 A1
(43) Pub. Date: Mar. 17, 2016

(54) SYSTEMS AND METHODS FOR ACHIEVING AND MAINTAINING BEHAVIORAL FITNESS

(71) Applicant: Cambia Health Solutions, Inc., Portland, OR (US)

(72) Inventors: Alexander Thorpe, Beaverton, OR (US); Max Janasik, Portland, OR (US); Stephen Erdmann, Lake Oswego, OR (US); Mohan Nair, Lake Oswego, OR (US); Steve Warming, Beaverton, OR (US); Marcie Traylor, Portland, OR (US)

(21) Appl. No.: 14/856,430

(22) Filed: Sep. 16, 2015

Related U.S. Application Data
(60) Provisional application No. 62/051,786, filed on Sep. 17, 2014.

(51) Int. Cl. A63B 24/00; G09B 19/00

(52) U.S. Cl. CPC A63B 24/0075; G09B 19/00; G09B 19/0092; A63B 2024/0081

(57) ABSTRACT

Systems and methods for adhering to a behavioral fitness routine are provided. In one embodiment, a method comprises receiving, from a user, a health balance goal for the user; receiving, from a coach, approval of the health balance goal; automatically generating a meal plan, a workout plan, and a mindfulness plan based on the health balance goal; receiving data indicating one or more user activities related to one or more of the meal plan, the workout plan, and the mindfulness plan; and automatically generating a user interface for display, the user interface visually depicting user progress towards meeting the health balance goal, the user progress based on the one or more user activities. In this way, a user's physical readiness for any situation and mental resilience within any situation may be increased.

### CROSS REFERENCE TO RELATED APPLICATIONS

The present application claims priority to U.S. Provisional Patent Application No. 62/051,786, entitled “SYSTEMS AND METHODS FOR ACHIEVING AND MAINTAINING BEHAVIORAL FITNESS,” filed on Sep. 17, 2014, the entire contents of which are hereby incorporated by reference for all purposes.

### BACKGROUND/SUMMARY

Many people seek to increase physical fitness levels and/or lose weight, and a variety of programs exist to help people exercise, eat healthy meals, etc. However, even given the advanced technology increasingly being incorporated into such programs, many people still find it difficult to maintain an exercise and/or diet routine. For example, such programs may not be tailored to a given user, may lack suitable progress monitoring, or may provide the user with an unsatisfactory solitary experience.

Fitness and readiness are especially important for military reserve members who must meet physical fitness requirements and constantly be prepared for combat mobilization. However, military reserve members live as civilians and are more or less isolated from the strongly regimented routines of military life. As such, achieving and maintaining a physically fit lifestyle can be challenging without proper motivation and guidance.

Furthermore, resilience is equally as important as physical fitness, especially for military reserve members. For example, even a physically fit military reserve member may find him or herself overwhelmed by the mental strain of combat. However, physical fitness programs typically lack adequate training for mindfulness and strong, positive attitudes. As such, many people, especially military reserve members, may benefit from a behavioral fitness program that offers holistic training for physical fitness and resilience.

The inventors have recognized the above issues and have devised several approaches to address them. In particular, systems and methods for adhering to a behavioral fitness routine are provided. In one embodiment, a method comprises: receiving, from a user via a user device, a health balance goal for the user; receiving, from a coach via a coach device, approval of the health balance goal; automatically generating a meal plan, a workout plan, and a mindfulness plan based on the health balance goal; receiving, from the user via the user device, data indicating one or more user activities related to one or more of the meal plan, the workout plan, and the mindfulness plan; and automatically generating a user interface for display via one or more of the user device and the coach device, the user interface visually depicting user progress towards meeting the health balance goal, the user progress based on the one or more user activities. In this way, users can establish reasonable fitness, nutrition, and wellness goals and can be held accountable to those goals by other users and stakeholders.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows an example computing environment.

FIG. 2 shows an example information flow.

FIG. 3 shows a high-level flow chart illustrating an example method for defining fitness goals.

FIG. 4 shows a high-level swim-lane flow chart illustrating an example method for monitoring fitness progress.

FIG. 5 shows a high-level flow chart illustrating an example method for creating a balanced meal plan.

FIG. 6 shows a high-level flow chart illustrating an example method for locating balanced meals at nearby restaurants.

FIG. 7 shows an example interface illustrating an example method for locating balanced meals at nearby restaurants.

FIG. 8 shows a high-level flow chart illustrating an example method for logging activity via text message.

FIG. 9 shows a high-level flow chart illustrating an example method for logging activity via a paper-based journal.

FIG. 10 shows an example interface for a detailed overview of weekly progress for a user and the user's team members.

FIG. 11 shows an example interface for a detailed overview of weekly progress for a user.

FIG. 12 shows an example interface for logging sleep notes.

FIG. 13 shows an example interface for displaying goals versus actual performance on a weekly basis.

FIG. 14 shows an example interface for a daily meal plan.

FIG. 15 shows an example interface for logging a meal.

FIG. 16 shows an example interface for creating a balanced meal recipe.

FIG. 17 shows an example interface for displaying weekly motivational images.

FIG. 18 shows an example interface for a leadership dashboard.

FIG. 19 shows an example interface for displaying aggregated qualitative metrics.

FIG. 20 is a schematic diagram illustrating an example network architecture for a behavioral fitness system.

FIG. 21 shows a block diagram illustrating a server system.

### DETAILED DESCRIPTION

The present description relates to systems and methods for achieving and maintaining physical fitness. In particular, systems and methods are provided for setting and tracking specific goals regarding fitness, mindfulness, sleep, and nutrition in the context of a prescribed behavioral fitness program to gain improvements in those areas and reporting on progress to stakeholders. As used herein, “stakeholders” refers to one or more coaches, team members, or other users who have an interest in the behavioral fitness of a given user. For example, a user of the systems and methods provided may be a member of a military reserve guard. As such, team members may refer to, for example, other reserve guard members with whom the user is familiar. A coach may refer to a military member with whom the user is familiar, or may refer to a person specifically trained to coach a user towards a balanced health. Other stakeholders may include military leadership, for example, military officers to whom the user may report.

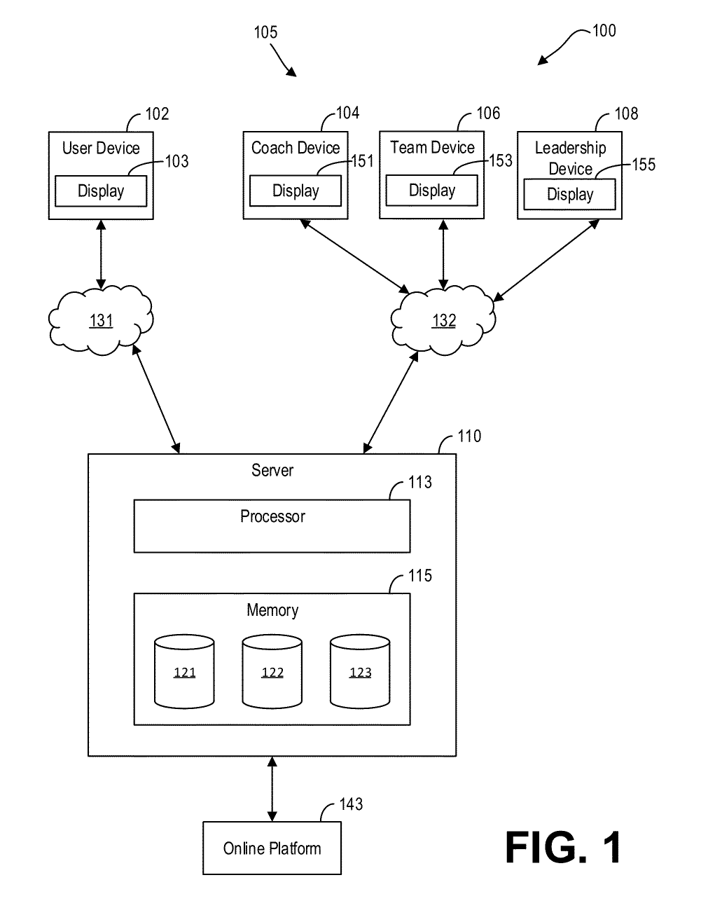

FIG. 1 shows an example computing environment 100 that can be configured to implement exemplary embodiments of the present invention. In particular, computing environment 100 illustrates the interaction between user device 102, coach device 104, team device 106, leadership device 108, and server 110.

User device 102 may comprise a computing device capable of receiving and transmitting information. User device 102 is shown in simplified form. However, user device 102 may take the form of one or more personal computers, server computers, tablet computers, home entertainment computers, network computing devices, gaming devices, mobile computing devices, mobile communication devices (for example, smart phone, smart watch, etc.), and/or other computing devices. As another example, user device 102 may comprise a cellular phone with or without functionality for connecting to a network such as the Internet. User device 102 may include a display 103.

Computing environment 100 may further include a variety of stakeholder devices 105, such as coach device 104, team device 106, and leadership device 108. Similar to user device 102, each stakeholder device 105 may comprise a computing device capable of transmitting information and is shown in simplified form. Each stakeholder device 105 may take the form of one or more personal computers, server computers, tablet computers, home entertainment computers, network computing devices, server computers, tablet computers, home entertainment computers, network computing devices, gaming devices, mobile computing devices, mobile communication devices (for example, smart phone), and/or other computing devices. Each stakeholder device 105 may include a display, such as display 151, display 153, and display 155.

Computing environment 100 may include a server 110. Server 110 may include a logic machine, such as processor 113. Processor 113 may include one or more physical devices configured to execute instructions. For example, processor 113 may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

Processor 113 may be single-core or multi-core, and the instructions executed thereon may be configured for sequential, parallel, and/or distributed processing. Individual components of the processor 113 optionally may be distributed among two or more separate devices, which may be remotely located and/or configured for coordinated processing. Aspects of the processor 113 may be virtualized and executed by remotely accessible, networked computing devices configured in a cloud-computing configuration.

Server 110 may further include a storage machine, such as memory 115, configured to hold instructions executable by processor 113 to implement the methods and processes described herein. When such methods and processes are implemented, the state of memory 115 may be transformed—for example, to hold different data. Memory 115 may include removable and/or built-in devices. Memory 115 may include optical memory (for example, CD, DVD, HD-DVD, Blu-Ray Disc, etc.), semiconductor memory (for example, RAM, EPROM, EEPROM, etc.), and/or magnetic memory (for example, hard-disk drive, floppy-disk drive, tape drive, MRAM, etc.), among others. Memory 115 may include volatile, nonvolatile, dynamic, static, read/write, read-only, random-access, sequential-access, location-addressable, file-addressable, and/or content-addressable devices.

Furthermore, server 110 may further include one or more databases in non-transitory memory 115, such as nutrition database 121, exercise database 123, and mindfulness database 125. In some examples, these databases may be designed to match military training routines and certain levels of military activity.

Server 110 may interact with user device 102 via network 131. In some examples, user device 102 may be a computing device configured with network connectivity, and so network 131 may comprise the public Internet, a private Internet, an intranet, and the like. In other examples, user device 102 may be a cellular phone with limited network functionality for connecting to, for example, the Internet, and so network 131 may comprise a cellular network. In yet other examples, user device 102 may comprise a plurality of devices with or without network connectivity, and so network 131 may comprise a plurality of networks such as the Internet and/or a cellular network.

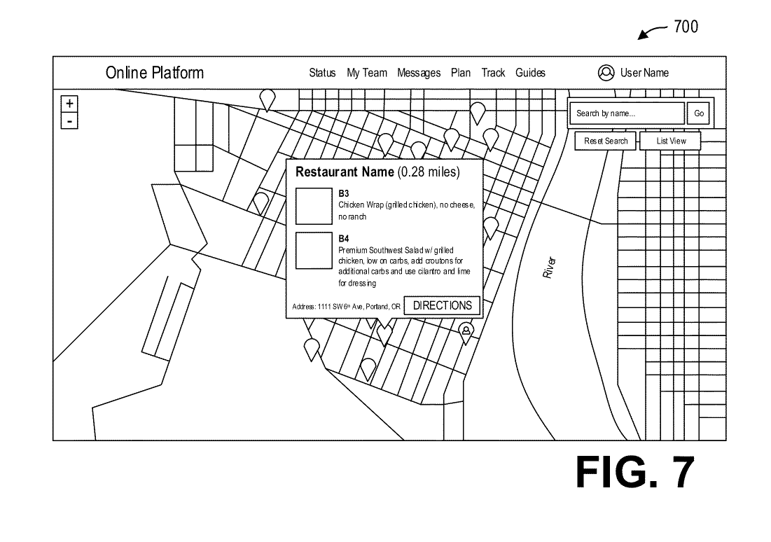

Server 110 provides an online platform 143 for tracking behavioral fitness progress. Users of user device 102 and stakeholder devices 105 may access online platform 143 in multiple ways, for example, via a website, a mobile phone application, text message, picture message, and the like. Online platform 143 provides an interface for establishing behavioral fitness targets, generating a plan to meet behavioral fitness targets, tracking progress towards behavioral fitness targets, determining the nutritional content of a meal, determining where to find balanced meals at nearby restaurants, communicating with coaches, team members, and leadership, and the like. Example interfaces for online platform 143 are described further herein and with regard to FIGS. 7 and 10-25.

In one example, computing environment 100 provides a system for remotely coaching an individual to improve mindfulness, fitness, sleep, and nutrition through accountability to system-identified stakeholders. Multiple tools may be integrated into the accountability system to facilitate setting adherence targets, capturing data, reporting on user's progress, and/or modifying the user's program to assist in achieving adherence targets.

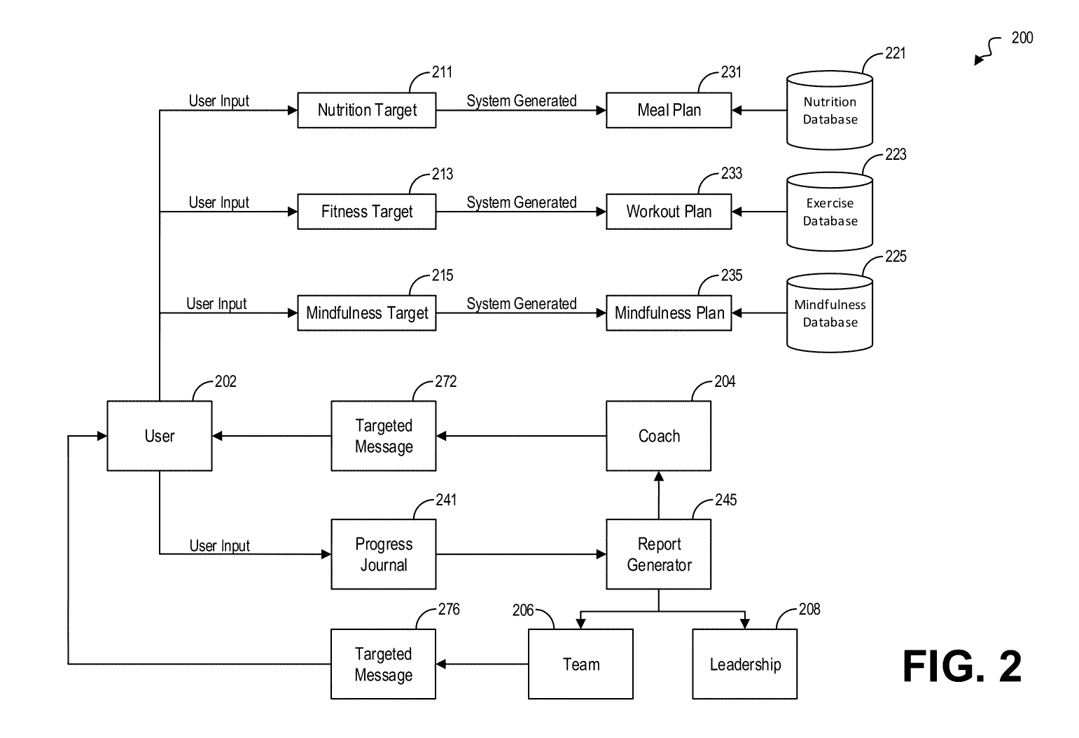

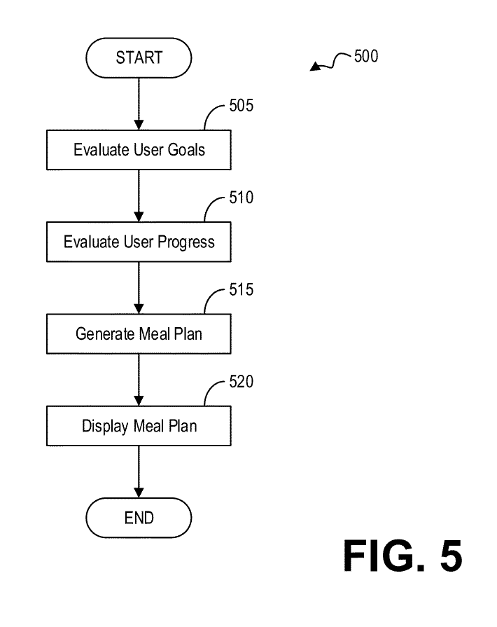

For example, server 110 may use information stored in non-transitory memory 115 to generate plans tailored to a user based on user-defined goals. For example, a user may set a nutrition target, a fitness target, and a mindfulness target. Server 110 may use these goals to generate a personalized meal plan using information from nutrition database 121, a personalized workout plan using information from exercise database 123, and a personalized mindfulness plan using information from mindfulness database 125. Generating user-specific plans based on user-defined goals is described further herein and with regard to FIGS. 2 and 5.

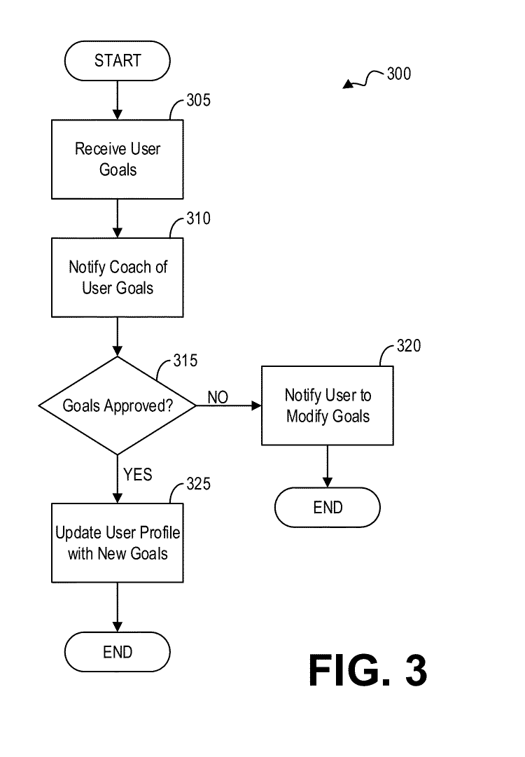

Further, the goals set by the user may be approved by a coach. A coach may be a friend, colleague, peer, and so on. In some examples, a coach may be, for example, a military veteran specifically trained with skills to effectively coach users towards meeting their goals. In this way, a user may work with an experienced coach on setting personal fitness, nutrition, and mindfulness goals. In another example, a coach may be a computerized entity. For example, server 110 may include software to emulate an experienced, human coach. A method for setting goals with approval from a coach is described further herein and with regard to FIG. 3.

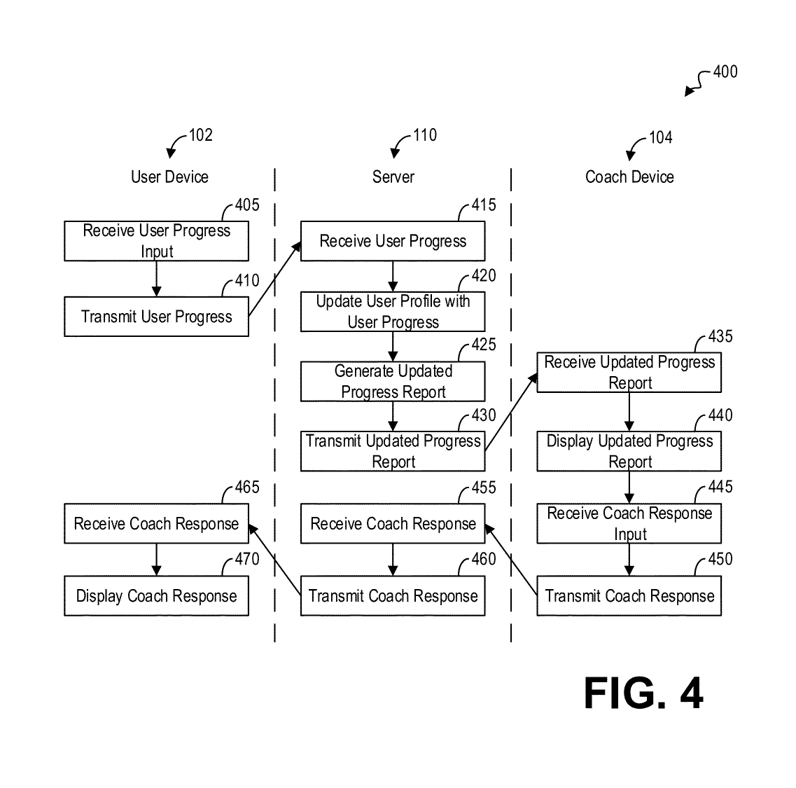

Online platform 143 may be used to log progress with respect to the plans and goals in a progress journal. Users may input activity such as exercise performed, meals consumed, number of hours of sleep, and so on via online platform 143. Online platform 143 may process the activity logged to generate a progress report which may be shared with stakeholders, such as a coach, team members, and leadership. Stakeholders may review progress reports and send targeted messages to the user in response to the progress reports. Logging activity in a progress journal, generating progress reports, and enabling communication between a user and a stakeholder is described further herein and with regard to FIGS. 2 and 4.

In one example, a customized meal plan may be generated by server 110 so that a user may know what and when to eat in order to meet his or her goals. A meal plan may comprise a specified number of meals and snacks at certain times in the day, where the meals and snacks may be balanced in terms of caloric content and macronutrient content (e.g., carbohydrates, protein, fat). In order to facilitate ease of consumption, meal plans may be presented in terms of B-Count targets. B-Counts represent a total number of calories in a balanced meal. In this way, a simple system is provided to a user so that the user may easily identify what to eat in order to meet his or her goals and to track their daily consumption. B-Counts are described further herein with regard to FIG. 5.

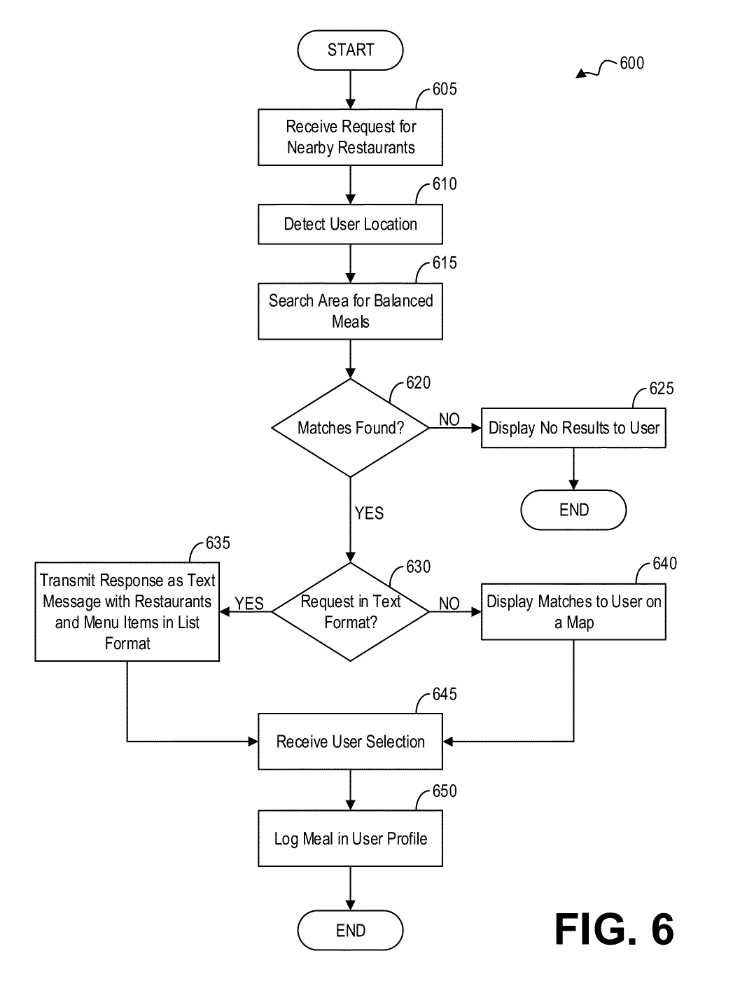

In order to facilitate adherence to a meal plan for users who may have busy or unpredictable schedules, users need an easy way to find balanced meals within target B-Counts at nearby restaurants and establishments. Hence, a geolocation feature is provided that allows users to identify nearby restaurants and establishments and view balanced meals within target B-Counts. A user may then log his or her consumption of these meals to count toward predefined nutrition targets. A method and interface for such a geolocation feature is described further herein and with regard to FIGS. 6 and 7.

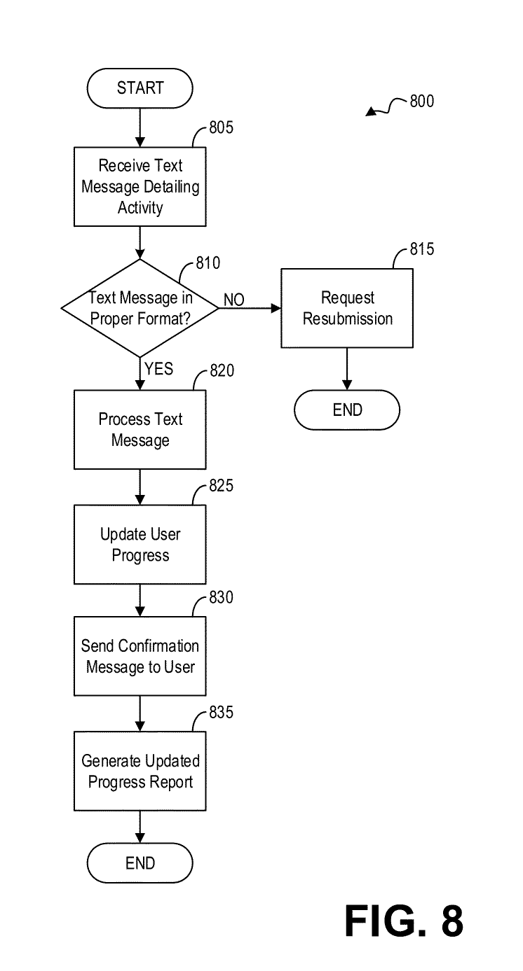

Some users may prefer not to use or may be unable to use online platform 143. For example, some users may not have a smart phone enabling simple interaction with a mobile application, or may not have regular access to the Internet. Such users may be accommodated in multiple ways. In some examples, a user may interact with online platform 143 via short message service (SMS), or a text message. For example, a user may send a text message containing a progress status to server 110 via a specified phone number. The text message may be formatted in a specific way in order for server 110 to interpret the text and update the user's profile. In these examples, user device 102 may be a cellular phone and network 131 may comprise a cellular network. A method for interacting with online platform 143 via text message is described further herein and with regard to FIG. 8.

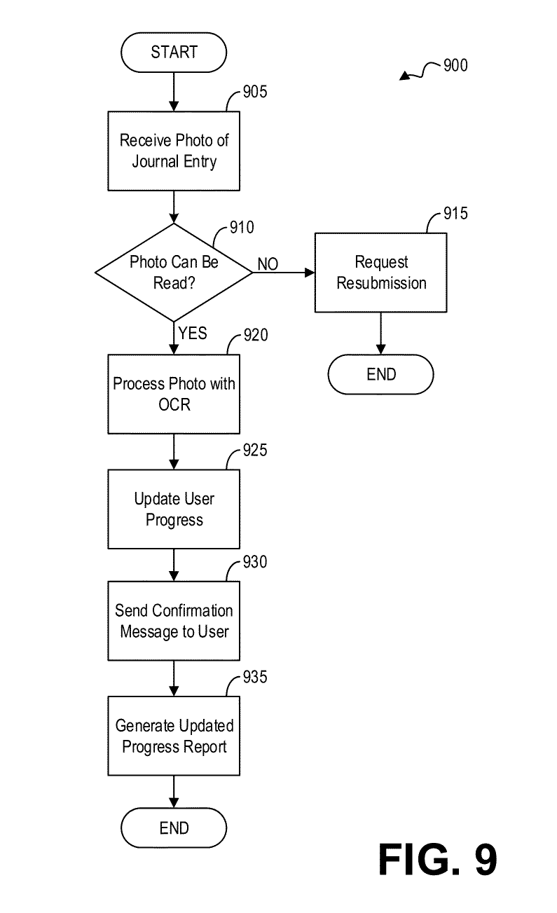

In other examples, a user may interact with online platform 143 via a photo message. For example, a user may prefer to log his or her workouts and meals in a physical journal throughout the day. The user may use a cell phone equipped with a camera to take a digital photograph of the journal page, and may send this digital photograph to server 110. The photograph may be sent as a picture message using, for example, a multimedia message service (MMS), electronic mail, and the like. Server 110 may use optical character recognition (OCR) technology to interpret the text on the journal page and update the user's profile with the interpreted text. A method for using a physical journal and OCR technology to track progress is described further herein and with regard to FIG. 9.

In some examples, a user may be grouped into a team of similar users. Such a team may comprise users who participate in the same military unit, live in the same geographical area, and so on. A team may include a single coach who coaches each member of the team and to whom each member is accountable. Furthermore, each user within a team may directly interact with other team members, for example, each user may be able to view individual and group statistics towards progress goals and communicate with one another about physical fitness and mindfulness. In this way, group cohesion may be developed while users participate in the fitness program. In some examples, each user may be assigned a team partner, or buddy, with whom they are more personally accountable. Server 110 may provide an interface that enables private communication and support between buddies, and in this way each user may be held personally accountable for him or herself as well as a buddy. In some examples, such teams may be structured similarly to groups within military units. For example, each team may comprise eight to fifteen users, similar to a military squad or section. In this way, the benefits of military organization, such as group cohesion, may be achieved.

In yet other examples, online platform 143 may provide one or more questionnaires to each user. Such questionnaires may be used to determine the physical and mental state of a user, and may be regularly administered in order to gain more in-depth knowledge regarding a user's progress towards physical and mental fitness.

FIG. 2 shows a schematic diagram illustrating an example information flow 200. Information flow 200 may represent the exchange of information between a user 202, a coach 204, a team 206, and leadership 208 via a computing environment, such as example computing environment 100. Information flow 200 will be described with regard to the systems and components of FIG. 1, though it should be understood that other systems and components may be used in accordance with the current disclosure.

User 202 inputs a variety of behavioral fitness goals, such as nutrition target 211, fitness target 213, and mindfulness target 215. Server 110 may generate customized plans for user 202 to follow in order to meet the user-input targets, such as a customized meal plan 231 for the nutrition target 211, a customized workout plan 233 for the fitness target 213, and a customized mindfulness plan 235 for the mindfulness target 215. For example, a meal plan may prescribe a number of meals with specified nutritional content, a fitness plan may prescribe a daily workout plan, and a mindfulness plan 235 may prescribe a daily meditation routine, a number of pages in specified books to read, a number of hours per night to sleep, and so on. In some examples, a mindfulness plan 235 may comprise the act of logging a user's physical activity and nutritional consumption on online platform 143, thereby increasing the user's mindfulness of their habits. In other examples, a mindfulness plan 235 may comprise a set of weekly mindfulness or resilience principles that a user may review and contemplate each week. Additionally, a user may set a resilience or mindfulness goal that corresponds to a weekly mindfulness principle, and may submit a motivational image that corresponds to the mindfulness goal. Such mindfulness images may be displayed throughout online platform 143 to the user and other users in order to serve as constant reminders of the mindfulness plan 235.

In some examples, the databases and system-generated plans may be designed to match military training routines and certain levels of military activity. For example, some aspects of fitness plans may include standard workouts implemented in basic military training. In this way, a user adhering to the system-generated plans may recall the experience of fitness obtained while actively serving in the military, and may therefore be more mentally and physically prepared for combat mobilization at a moment's notice.

As the user 202 follows the system-generated plans, user 202 tracks progress in a progress journal 241. Progress journal 241 is a log of all user activity towards the specified goals. In some examples, progress journal 241 may have a paper-based analog that a user may primarily utilize for tracking personal progress. In such examples, the user may upload photographs of the paper-based journal entries, and server 110 may, for example, use OCR technology to interpret the photographs and update progress journal 241 with the interpreted journal entry.

Progress journal 241 and report generator 245 may be associated with a user profile on a social media platform, such as online platform 143. Report generator 245 utilizes information in progress journal 241 to generate progress reports. Coach 204 may review the progress reports generated by report generator 245, and may send a targeted message 272 to user 202. For example, targeted message 272 may comprise a note of encouragement, advice, reprimands, and the like. Similarly, team 206 comprising similar users may review the progress reports generated by report generator 245, and may send a targeted message 276 to user 202. Further, in some examples leadership 208 may review the progress reports and may also send a targeted message (not shown) to user 202. In this way, the progress of user 202 may be reviewed and commented on by interested parties. This system of review and communication may increase accountability for user 202, and serve as encouragement to follow the plans and therefore meet the targets. Furthermore, this system may comprise a social media platform that encourages open communication between all parties involved regarding progress and activity.

FIG. 3 shows a high-level flow chart illustrating an example method 300 for establishing goals with the approval of a coach. Method 300 will be described with reference to the systems and components of FIGS. 1 and 2, however the method may be applied to other systems and components without departing from the scope of this disclosure. Method 300 may be implemented as instructions in non-transitory memory on server 110.

Method 300 may begin at 305. At 305, method 300 may include receiving user goals. User goals may be input by a user 202 on user device 102 and sent to server 110 via network 131. User goals may include, as general examples, target goals regarding fitness, nutrition, and mindfulness. Particular examples of user goals may include a desired body weight, workout targets (for example, running five kilometers in less than half an hour, bench pressing 110% of the user's body weight, etc.), an amount of nightly sleep, and so on. Method 300 may then proceed to 310.

At 310, method 300 may include notifying a coach 204 of user goals. Notifying a coach 204 of user goals may comprise, for example, sending a message to coach device 104 indicating that user 202 has chosen goals. Coach 204 may review the user goals on coach device 104 and determine if the goals are appropriate for user 202. Determining if the goals are appropriate for user 202 may include considering the goals given the details of the user 202. For example, if the user currently weighs 300 pounds and chooses a goal of losing 100 pounds in one month, the coach may recognize that the goal is unfeasible given the circumstances. As another example, if the user sets a goal of doing strength training workouts for three hours a day every day of the week, the coach may recognize that such a workout schedule may be unreasonable in light of the user having a full-time job and a family life, which may be details included in a profile set up by the user. As another example, if a user submits a sleep target that includes a very large or very small number of hours of sleep per night, the coach may recognize that such sleeping habits are unhealthy.

Continuing at 315, method 300 may include determining if the user goals are approved by the coach 204. If the user goals are not approved, method 300 may proceed to 320. At 320, method 300 may include notifying user 202 to modify his or her goals in order to obtain approval from coach 204. In some examples, notifying user 202 to modify goals may include a targeted message from coach 204 indicating why the goals were not approved and/or how to modify the goals. Considering the examples discussed above, the coach may, for example, suggest a more feasible weight loss plan, or may recommend, for example, an intense workout routine that covers all aspects of physical fitness and may be accomplished in less time per day. As another example, the coach may suggest a number of hours to sleep each night that may benefit the user's mental and physical health. Method 300 may then end. After method 300 ends and the user reviews the message from coach 204, method 300 may begin again when user 202 submits new goals based on the message from coach 204. In this way, the user 202 and coach 204 may establish personally-tailored goals for user 202 by communicating with each other.

Returning to 315, if the user goals are approved, method 300 may proceed to 325. At 325, method 300 may include updating the user profile for user 202 with the new personalized goals. In some examples, method 300 may further include generating new customized plans for the user goals. Method 300 may then end.

FIG. 4 shows a high-level swim-lane flow chart illustrating an example method 400 for tracking user progress. In particular, method 400 illustrates how server 110 interacts with user device 102 and coach device 104 to track user progress and provide targeted messages from coach device 104 to user device 102. Method 400 includes coach device 104, however in some examples the steps associated with coach device 104 may also be applied to another stakeholder device, such as team device 106 and/or leadership device 108.

Method 400 may begin at 405. At 405, user device 102 may receive user progress input from a user 202. User progress may be input in multiple ways. In examples where user device 102 is a mobile computing device (e.g., a smart phone), user progress may be input as text in a mobile device application. In examples where user device 102 is a personal computer or laptop, user progress may be input as text in an interface displayed via an internet browser. In examples where user device 102 is a cellular phone, user progress may be input as text in a text message format or as a digital photograph of a paper-based journal.

After user device 102 receives the user progress input, method 400 may include transmitting the user progress from user device 102 to server 110. Transmitting user progress from user device 102 to server 110 may occur over a network 131. Network 131 may comprise a public Internet if user device 102 is capable of accessing the Internet, or network 131 may comprise a cellular network if user device 102 is a cellular device.

At 415, server 110 may receive the user progress transmitted from user device 102. In some examples, method 400 may further include processing the received user progress depending on the transmission format. For example, if the user progress is received in the form of a digital photograph, server 110 may use OCR technology to process the photograph and interpret any text detected in the photograph. As another example, if the user progress is received in the form of a text message, server 110 may process the text message and interpret the text.

Continuing to 420, server 110 may update a user profile with the received user progress. The user profile may be associated with the user 202 of user device 102. Method 400 may then proceed to 425.

At 425, server 110 may generate an updated progress report based on the user progress. The progress report may visually or textually depict the overall user progress towards the user goals.

After server 110 generates an updated progress report, method 400 may continue to 430. At 430, server 110 may transmit the updated progress report to a stakeholder device, such as coach device 104.

At 435, coach device 104 receives the updated progress report. At 440, coach device 104 displays the updated progress report so that the coach 204 may review the progress of user 202. After reviewing the progress report, coach 204 may choose to send a targeted message 272 to user 202. Targeted message 272 may comprise, for example, a note of encouragement, advice for how to improve, reprimands for not satisfying expectations, and so on.

If coach 204 chooses to send a targeted message 272, method 400 may continue to 445. At 445, method 400 may include receiving coach response input. Continuing at 450, coach device 104 may transmit the coach response to server 110.

At 455, server 110 may receive the coach response. In some examples, server 110 may store the coach response in non-transitory memory for later retrieval. At 460, server 110 may transmit the coach response to user device 102.

At 465, user device 102 may receive the coach response, and at 470, user device may display the coach response to user 202.

In this way, user 202 may be accountable for his or her progress and may be motivated to follow a fitness plan and therefore meet the established goals.

FIG. 5 shows a high-level flow chart illustrating an example method 500 for generating a meal plan appropriate for the nutritional goals and overall progress of a user. In particular, method 500 relates to the creation of balanced meals and the assignment of a caloric range based on circumstance and physical attributes of a user for each of six meals during three time periods during the day. B-Counts may represent the total amount of calories in each of the three time periods, and are described further herein. Method 500 may be stored as executable instructions in non-transitory memory on server 110.

Method 500 may begin at 505. At 505, method 500 may include evaluating user goals. Evaluating user goals may include evaluating targets such as nutrition targets, fitness targets, and mindfulness targets. For example, a user goal may include reaching a particular combination of body weight, body fat percentage, and/or body mass index. Evaluating user goals may further include evaluating the system-generated plans for achieving targets, such as a previously-generated meal plan, workout plan, and mindfulness plan. Method 500 may then continue to 510.

At 510, method 500 may include evaluating user progress. Evaluating user progress may comprise evaluating the actual progress of the user, including actual nutritional intake and workouts. Evaluating actual progress of the user enables server 110 to determine a meal plan appropriate to the user's goals and progress.

At 515, method 500 may include generating a personalized meal plan. Generating a personalized meal plan may comprise determining daily caloric intake based on the user goals and progress. For example, prescribed caloric intake may be increased on days where the user exercises more and burns more calories, or decreased on days where the user does not have a rigorous workout routine. To generate a meal plan, a twenty-four hour period may be divided into three sections: morning, afternoon, and evening. The meal plan may include a meal and a snack assigned to each section, where the meal and the snack may be consumed, for example, no more than three hours apart.

Each meal and/or snack may be balanced according to the percentage of calories from protein, carbohydrates, fat, and macronutrient level. For example, each meal or snack may be balanced according to the percentage of calories from protein (30-40%), carbohydrates (40-50%), fat (15-25%) and level of macronutrients. In some examples, caloric intake may be described in terms of a B-Count, where a B-Count corresponds to a total number of calories in each of the three time sections. A balanced meal may be assigned a B number according to the range of its total calories. In some examples, B numbers may defined such that B0 corresponds to zero calories, B1 corresponds to 1-100 calories, B2 corresponds to 101-200 calories, and so on. In other examples, B numbers may be defined on a different calorie scale. The total B-Count for the consumed meals may be plus or minus one of the target B-Count assigned to the user. In this way, a user may easily know what to eat and drink and at what time in order to lose weight, as the user only needs to track the B-Count rather than the specific nutrition content for each meal or snack. Thus, generating a meal plan may comprise assigning a B-Count target for each time section based on the biometrics and physical activity of the user.

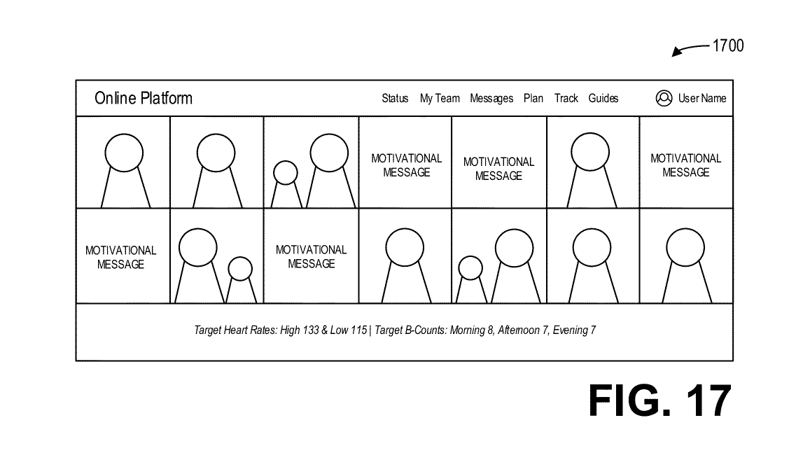

At 520, method 500 may include displaying the personalized meal plan. Displaying the meal plan is discussed further herein and with regard to FIG. 17. Method 500 may then end.

Thus, a system and method for identifying what to eat and when to eat is provided. In particular, the B-Count system described hereinabove provides a simplified way to easily identify the nutritional content of a balanced meal without needing to know the specific details of the meal, and therefore enables simple tracking of consumption.

FIG. 6 shows a high-level flow chart illustrating an example method 600 for identifying balanced meals appropriate for a nutrition plan while a user is on the go, e.g., away from home.

Method 600 may begin at 605. At 605, method 600 may include receiving a request from a user for nearby restaurants. Method 600 enables users to easily identify or modify meals at restaurants and establishments in their area while on the go.

At 610, method 600 may include detecting the location of the user. In one example, detecting the location of the user may comprise obtaining GPS coordinates of user device 102. In another example, detecting the location of the user may comprise receiving a location input by the user. For example, the user may include his or her location in the request at 605.

At 615, method 600 may include searching the area of the user location for balanced meals. In one example, searching the area of the user location for balanced meals may comprise searching a pre-determined list of restaurants stored on server 110. In another example, searching the area of the user location for balanced meals may comprise identifying local restaurants with online menus and analyzing the menus to determine if a menu item within a target B-Count is offered.

At 620, method 600 may include determining if a match is found. If no match is found, method 600 may proceed to 625. At 625, method 600 may include displaying no results to the user. In some examples, method 600 may further include displaying alternative options such as nearby grocery stores, or advice for independently identifying a balanced menu item. Method 600 may then end.

Returning to 620, if a match is found, method 600 may continue to 630. At 630, method 600 may include determining if the initial user request was in a text message format. Note that method 600 refers to a text message, however any message format may be utilized. For example, the user request may take the form of a multimedia message. If the request was in text message format, method 600 may continue to 635. At 635, method 600 may include transmitting a response as a text message to the user, where the response comprises restaurant locations and menu items in list format. If the user chooses to consume one of the proposed menu items, the user may send a text message response indicating the consumed menu item.

Returning to 630, if the request is not in text message format, method 600 may continue to 640. At 640, method 600 may include displaying matches to the user on a map within the mobile application. The user may browse the restaurants displayed on the map, for example by selecting the restaurant name or location, and view the balanced menu items. An example interface for displaying local restaurants that offer balanced menu items is described further herein with regard to FIG. 7. If the user chooses to dine at a particular restaurant, the user may select the menu item within the application to indicate that the user will consume the menu item.

Whether the user browsed restaurant options and selected a menu item via text message at 635 or on a mobile application at 640, method 600 continues to 645. At 645, method 600 may include receiving the user selection. In examples where the user selection is received via text message, method 600 may further include logic to properly process the user selection. Such logic is described further herein with regard to FIG. 8.

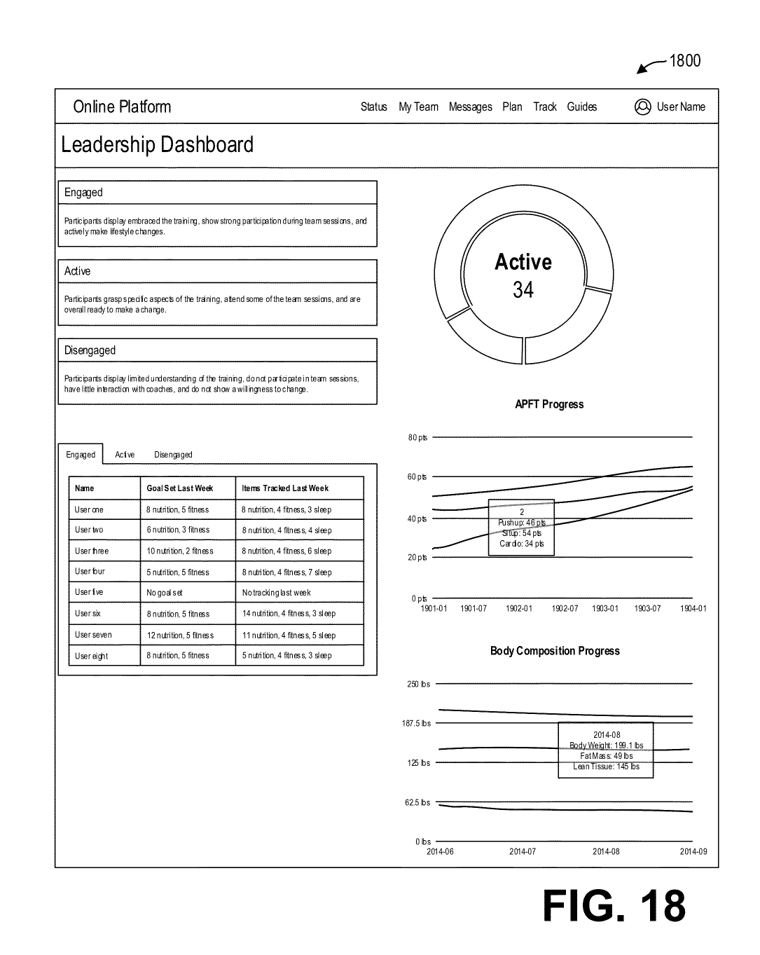

At 650, method 600 may include logging the selected meal in the user profile, as described further herein with regard to FIG. 18. Method 600 may then end.

FIG. 7 shows an example interface 700 illustrating an example method for locating balanced meals at nearby restaurants. In particular, interface 700 displays a geolocation restaurant guide. Interface 700 may comprise the interface displayed to a user at step 640 in method 600, for example. Interface 700 may include a marker indicating a user's location, in addition to markers indicating the location of restaurants that offer balanced meals. A user can click on one of the restaurant markers to view more detailed information. As shown, interface 700 may display a list of menu options listed by B-Count, as well as location information such as an address and distance from the user's current location. Interface 700 may further offer directions to the restaurant upon the user's request.

FIG. 8 shows a high-level flow chart illustrating an example method 800 for updating progress via text message. Not all users will have access to the online platform or a smartphone. Therefore, users need a way to update their progress in near real-time without access to the Internet. Text messages allow participants to track and log their fitness, nutrition, and mindfulness activities to be captured by the online platform. As described herein, user data sent via text may be parsed by the system and automatically uploaded to the database for graphic display and reporting. While method 800 relates to the use of text messages, it should be appreciated that method 800 may be applied to other messaging formats, such as picture messages, e-mails, physical mail, and so on.

Method 800 may begin at 805. At 805, method 800 may include receiving a text message detailing user activity.

At 810, method 800 may include determining if the text message is in a proper format. A proper format for the text message may comprise, for example, a specified syntax to aid an interpretation of the message by server 110. A proper format may further comprise a sufficient amount of detail. As an illustrative and non-limiting example, a properly formatted text message detailing a cardio workout comprising jogging three miles in 27 minutes beginning at 6:30 P.M. may read “Jogging; 3 miles; 27 min; 18:30” while an improperly formatted text message may read “ran 3 miles in 27.” If the text message is not in the proper format, method 800 may continue to 815. At 815, method 800 may include requesting resubmission. Requesting resubmission may comprise sending a text message to the user indicating that the text message received was improperly formatted, and request to resubmit the activity update in the proper format. Method 800 may then end.

Returning to 810, if the text message is in the proper format, method 800 may continue to 820. At 820, method 800 may include processing the text message.

At 825, method 800 may include updating the user progress. After the user profile is successfully updated with the user progress, method 800 may proceed to 830.

At 830, method 800 may include sending a confirmation message to the user.

At 835, method 800 may include generating an updated progress report based on the updated user progress. Method 800 may then end.

Thus, a method and apparatus are provided for users to track and log progress in online platform 143 via text message. In this way, users may text progress toward fitness, nutrition, sleep, and mindfulness activities to be auto-populated into their online profile.

FIG. 9 shows a high-level flow chart illustrating an example method 900 for updating a user's progress with a photo of the user's journal. Not all participants will have access to the web platform or want to use the platform to track their progress. Participants who would prefer to track their progress in a physical journal need a way to update their progress on the platform. Optical character recognition (OCR) allows participants to track and log their fitness, nutrition, and mindfulness activities in a physical journal to be uploaded into the platform. A photo uploaded by participants will be parsed by the system, uploaded, and automatically inserted into the database for graphic display and reporting.

Method 900 may begin at 905. At 905, method 900 may include receiving a digital photograph of a journal entry.

At 910, method 900 may include determining if the photo can be read. In one example, the photograph may be too blurry for OCR software to correctly process the image. In another example, the photograph may be clear but the handwriting may be illegible. Thus, determining if the photo can be read may comprise determining if any handwriting identified in the photograph is, for example, substantially blurred. If the photo cannot be read, method 900 may continue to 915.

At 915, method 900 may include requesting resubmission. Requesting resubmission may comprise sending a message to the user indicating that server 110 could not process the photograph, and requesting the user either submit another photograph of the journal entry or submit a photograph of a rewritten journal entry. Method 900 may then end.

Returning to 910, if the photo can be read, method 900 may continue to 920. At 920, method 900 may include processing the photo with optical character recognition software to detect any text in the journal entry. The user activity detailed in the journal entry may be interpreted from the detected text.

At 925, method 900 may include updating the user progress.

At 930, method 900 may include sending a confirmation message to the user.

At 935, method 900 may include generating an updated progress report. Method 900 may then end.

Hence, a method and apparatus is provided for users to upload their progress tracked in a physical journal into the online platform 143. Optical character recognition technology enables users to take a picture of their physical entries of progress toward fitness, nutrition, and mindfulness activities to be auto-populated into their online profile.

When setting up an account, a sign-up interface may enable a user to enter personal information such as name, contact information, age, gender, typical activity level, height, weight, and the like. The sign-up interface may further include input fields to provide additional details regarding the user, for example, work schedule, typical daily routine, and so on.

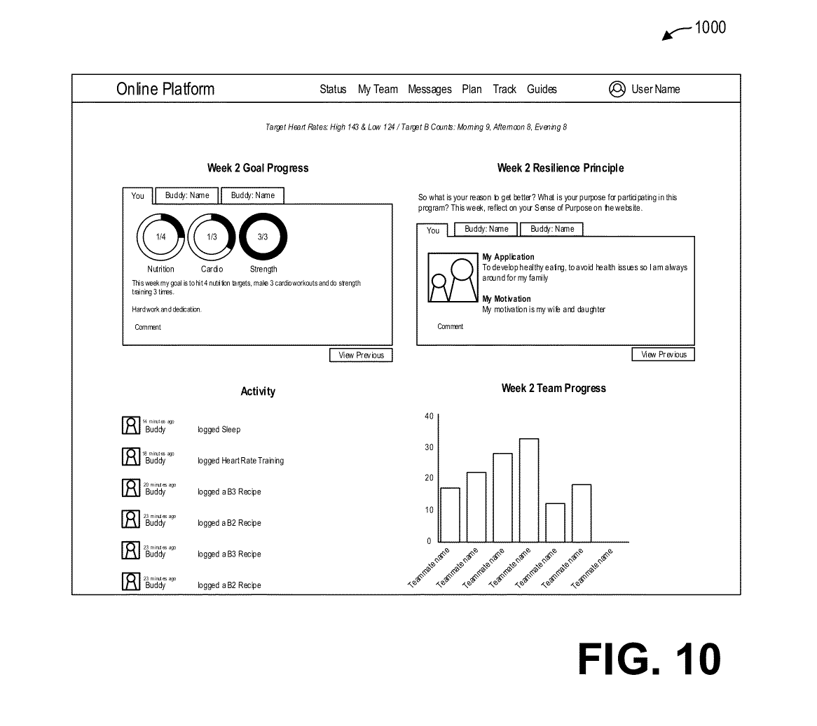

FIG. 10 shows an example interface 1000 for displaying a detailed overview of weekly progress towards personal targets for both a user and the user's team members and/or buddies. Interface 1000 may display information regarding goal progress, resilience principles, buddy activity, and overall team progress.

Interface 1000 may display each target goal category as a circle, for example, with a percentage of the circle's circumference highlighted corresponding to the number of targets achieved in that target category. As shown, 2/11ths of the nutrition target category is highlighted in order to convey that the user has logged 2 nutrition achievements while the user has set 11 nutrition targets as a goal. The entire cardio target category circle is highlighted in order to convey that the user has logged 2 cardio workouts while the user has set 2 cardio workouts as a goal. Similarly, half of the strength target category circle is highlighted in order to convey that the user has logged 1 strength achievement while the user has set 2 strength targets as a goal for the week. Note that interface 1000 may further include a tab for one or more team partners, or buddies, so that a user may view similar detailed information for the weekly progress of a team partner. In this way, a user may experience the mutually competitive and supportive attitude familiar to the user from military training.

Interface 1000 may display resilience principle information, such as a motivational image, a user-input motivation, and a user-input motivation. Interface 1000 may include such resilience principle information in order to provide a reminder of the user's motivation for adhering to the behavioral fitness program. Interface 1000 may further include a tab for one or more buddies so that a user may view similar resilience principle information for a team partner. In this way, a user may be develop a healthy mindfulness practice and stay motivated towards his or her goals.

Interface 1000 may further include an activity log for the user and the user's buddies. In this way, a user can view a detailed activity timeline and see that the user and/or other users are adhering to the program. Interface 1000 displays all activity logged by the user, including detailed workout information, meals consumed, and the time each activity occurred. Interface 1000 may further include a commenting feature so that the user and other stakeholders may comment on each logged activity. In this way, online platform 143 may function as social media, meaning that users may interact with logged activity of their own as well as other users. For example, a coach or a team member may user interface 1000 to comment on a meal or a workout logged by a user. In this way, the user experience of working towards his or her fitness goals is similar to the experience of military life.

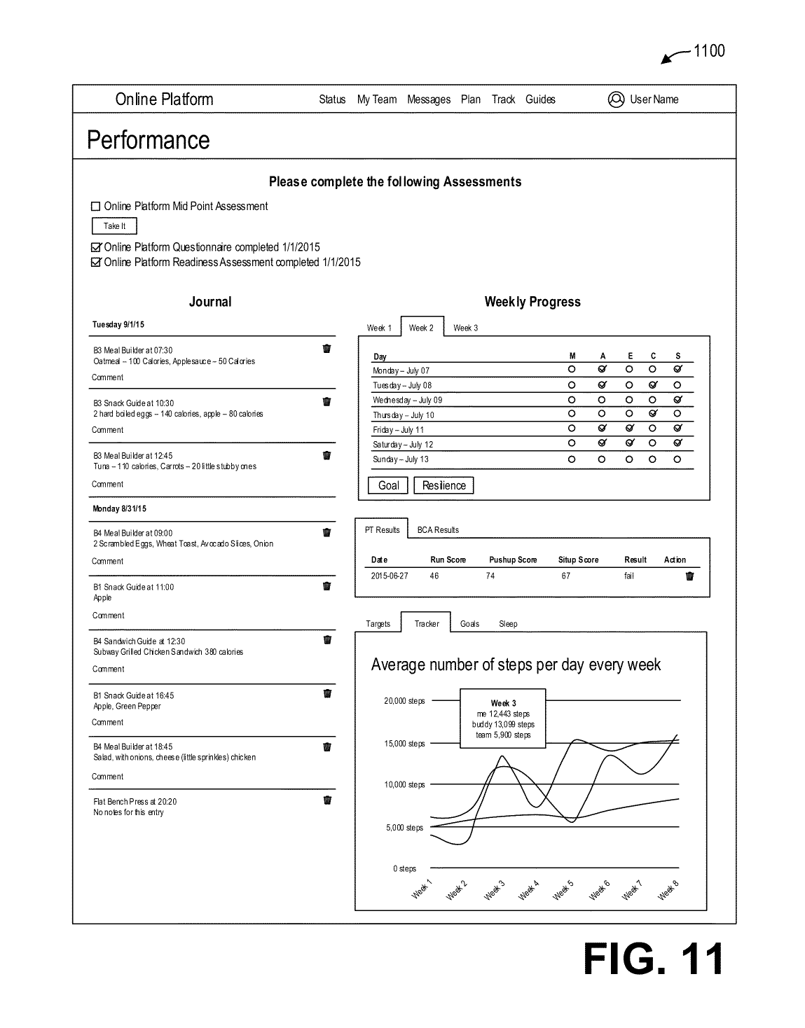

FIG. 11 shows an example interface 1100 for a detailed overview of weekly progress for a user. Interface 1100 may display information regarding complete or incomplete self-assessments, detailed weekly progress towards goals, a detailed overview of a user's journal, and weekly physical activity. For example, a user may use a pedometer to track the number of steps every day and upload such data to the server 110. Interface 1100 may then display, for example, the average number of steps per day.

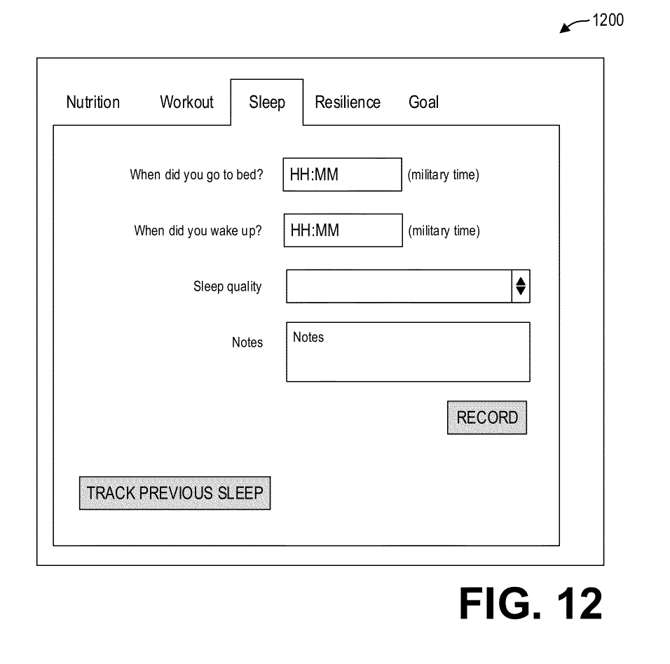

FIG. 12 shows an example interface 1200 for logging sleep information. Interface 1200 may include user inputs for data regarding sleep, such as when the user went to bed, when the user woke up, the quality of the sleep, and any notes regarding sleep. Server 110 may use data input to calculate total hours slept. In this way, a user can track their actual progress towards sleep goals. For example, if a user sets a goal of getting eight hours of good sleep every night, interface 1200 provides a simple way to determine if such goals are being achieved. In one example, sleep quality may be scored on a scale, for example from 1-4.

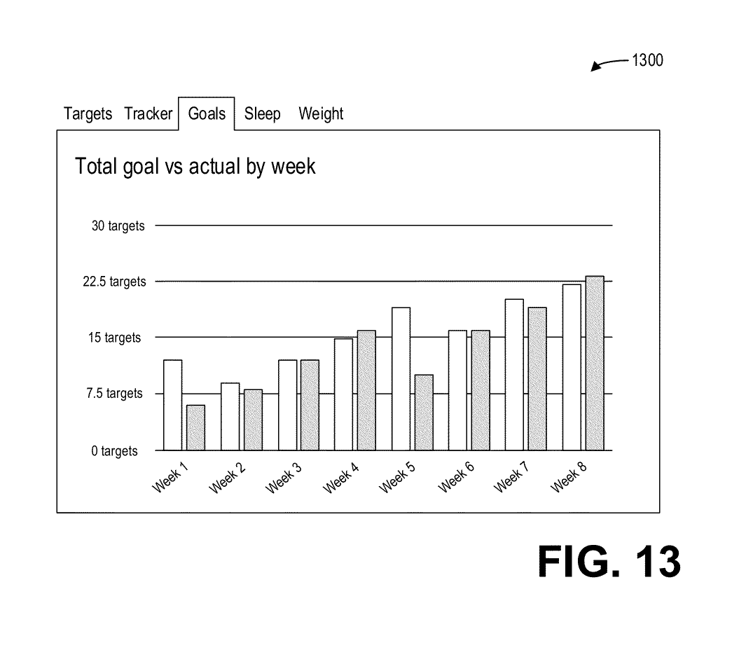

FIG. 13 shows an example interface 1300 that visually depicts target goals versus actual performance. In particular, interface 1300 displays a bar graph comparing goals targeted and actual goals achieved per week. In this way, online platform 143 may present an at-a-glance view of progress success.

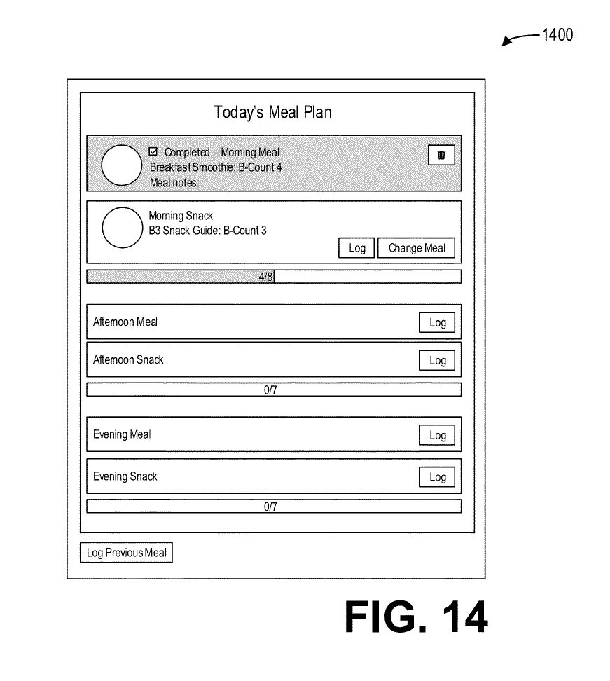

FIG. 14 shows an example interface 1400 for a daily meal plan in accordance with the current disclosure. In particular, interface 1400 shows an interactive daily meal plan log. Interface 1400 shows the three time sections—morning, afternoon, and evening—and target B-Counts for each section. In the example shown, the target B-Count for morning is 8, the target B-Count for afternoon is 7, and the target B-count for evening is 7. Interface 1400 displays what meals and snacks have been logged, including the B-Count and any meal notes input by the user. In the example shown, the user has logged the completed consumption of a morning meal comprising a breakfast smoothie with a B-Count of 4, and an intended consumption of a morning snack with a B-Count of 3. Note that interface 1400 further includes an option to log previous meals and an option for editing logged meals.

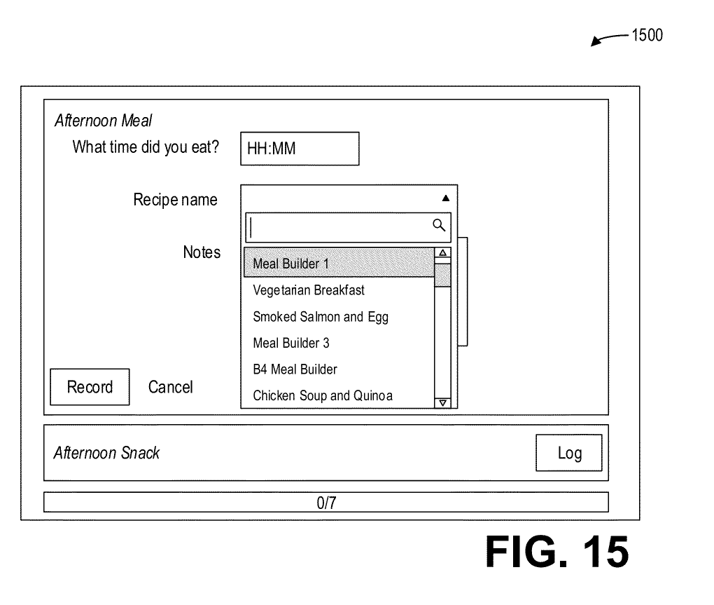

In order to log a meal, a user may click on a “Log” button corresponding to the meal or snack the user would like to log. FIG. 15 shows an example interface 1500 for logging a meal. In particular, interface 1500 depicts input fields displayed after clicking a “Log” button on interface 1400. As shown, interface 1500 may include a time field for inputting the time a meal or snack was consumed, a drop-down list containing all balanced meal recipes stored on server 110, and a text field for meal notes.

In some examples, server 110 includes an interactive repository of balanced meal recipes that may be accessed via online platform 143. Users may search recipes by name, ingredients, cuisine, and B-Count. Users may view meal recipes, add reviews of a meal recipe, and add a recipe for a balanced meal.

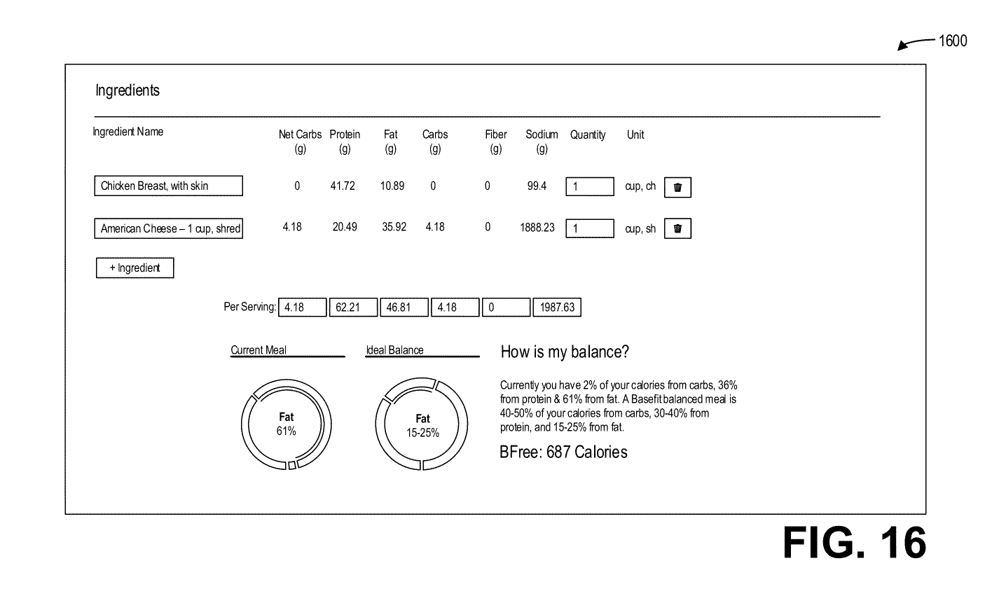

FIG. 16 shows an example interface 1600 for creating a recipe for a balanced meal in accordance with the current disclosure. A user may select ingredients for a recipe, and server 110 displays the ingredient on interface 1600 along with nutritional information from nutrition database 121. As shown, nutritional information may include, but is not limited to, net carbohydrates, protein, fat, carbohydrates, fiber, and sodium. The quantity of each ingredient may be adjusted according to the recipe. Server 110 computes overall nutritional value of the meal and shows a breakdown of the nutritional content. Interface 1600 may further include an interactive visual depiction of the nutritional balance for the recipe in addition to a visual depiction of an ideal nutritional balance. In the example shown, a recipe comprising one cup of chicken breast with skin and one cup of shredded American cheese contains 61% fat, 36% protein, and 2% carbohydrates. The meal balance and the ideal balance are depicted in a circular form with each component—fat, protein, and carbohydrates—forming a percentage of the circumference. Interface 1600 may further include an overall B-Count computed by server 110 using nutrition information from nutrition database 221.

After building a meal recipe using interface 1600, a user may save the recipe on server 110 so that the recipe may be accessed via online platform 143. In this way, the user may easily access the recipe when logging meals, share the recipe with other users, and receive comments on the specific meal recipe.

In some examples, a user may submit a recipe to the interactive recipe repository on server 110 without using interface 1600. For example, a user may write a recipe in his or her paper-based journal and submit a photograph of the journal entry containing the recipe. Server 110 may then process the image, interpret the recipe, and generate a B-Count for the recipe using nutritional information from nutrition database 221. In another example, a user may send a message, such as a text message or a picture message, containing the recipe. Server 110 may then process the message, interpret the recipe, and generate a B-Count for the recipe using nutritional information from nutrition database 221. In another example, a user may find a recipe while searching on the Internet and may like to know the B-Count for the recipe. Thus, server 110 may include an interface for users to submit web pages containing recipes. Server 110 may interpret the recipe on the web page and generate a B-Count for the recipe. Such an interface may take the form of a web page on online platform 143, or may, for example, take the form of a browser plug-in that allows the user to click a button to automatically process a recipe on a web page. In all examples, server 110 may include an interface similar to interface 1600 that displays the B-Count of a recipe to a user. In this way, a user may determine the B-Count of a recipe with minimal effort.

In some examples, the server 110 may include one or more interfaces enabling a user to select weekly motivational images and resilience principles. Such an interface may display encouraging information regarding resilience principles. A user may reflect upon this information and choose a motivational image that embodies the resilience principles displayed. To that end, the interface may further enable a user to upload a weekly motivational image that may displayed to the user and other team members each week. Further, the interface may include inputs for a user to describe how the user will implement the weekly resilience principle, the motivation for a user to implement the weekly resilience principle, and a weekly motivational image.

FIG. 17 shows an example interface 1700 for displaying weekly motivational images. Interface 1700 may display an array of one or more weekly motivational images that reflect the resilience principles displayed via the interface described herein above, for example. Interface 1700 may be accessible to each member of a team, and may include motivational images submitted by each team member. In some examples, interface 1700 may display motivational images submitted by all users in a user's location. Each motivational image may comprise a photograph of, for example, each user's family, a motivational message, and so on. In this way, users may view the motivational images of similar users, thereby developing cohesion between the users.

Interface 1700 may further include a brief overview of weekly physical goals set by the user. In this way, a user may contemplate the goals set while viewing the motivational images that he or she submitted.

In some examples, the server 110 may include one or more interfaces that enable direct communication between team members and a coach. Secure messages may be exchanged via server 110 between team members and a coach. In this way, a user may directly communicate in private with a coach and/or one or more team members via online platform 143.

In other examples, the server 110 may include one or more interfaces that enable open communication between team members and a coach. Such an interface may comprise a team page for a particular team. On a team page, users may post text, images, links to external sites, videos, and comments. In some examples, a team page may be private such that only users who are members of the team may visit the team page. In this way, team members may openly communicate and exchange information with one another.

The server 110 may further include one or more interfaces that display aggregated information for a leader, such as a coach or other stakeholders. FIG. 18 shows an example interface 1800 for a leadership dashboard. The leadership dashboard offers a real-time measurement of all user interactions through the online platform, activity monitor data streams, and personal health coaching measurements. The dashboard delivers actionable reporting to engage with users in their training earlier and more effectively when compared to traditional aggregate reporting, thereby improving training delivery, personalization, and adherence. The primary metric of the interface 1800 is a qualified measurement of participant engagement based on multiple criteria and health coach interactions. The user engagement score rates individual participants on their personal engagement in the online platform training experience using a three-point scale: engaged, active, and disengaged. Engaged participants embrace the training, show strong participation during team sessions, and actively execute lifestyle changes. Active participants grasp specific aspects of the training, attend some of the team sessions, and are overall ready to make a change. Disengaged participants display limited understanding of the training, do not participate in team sessions, have little interaction with coaches, and do not show a willingness to change. The engagement metric used is a combination of quantitative data points gathered from the online platform, combined with a qualitative measure by health coaching staff based on in-person and telephonic interactions.

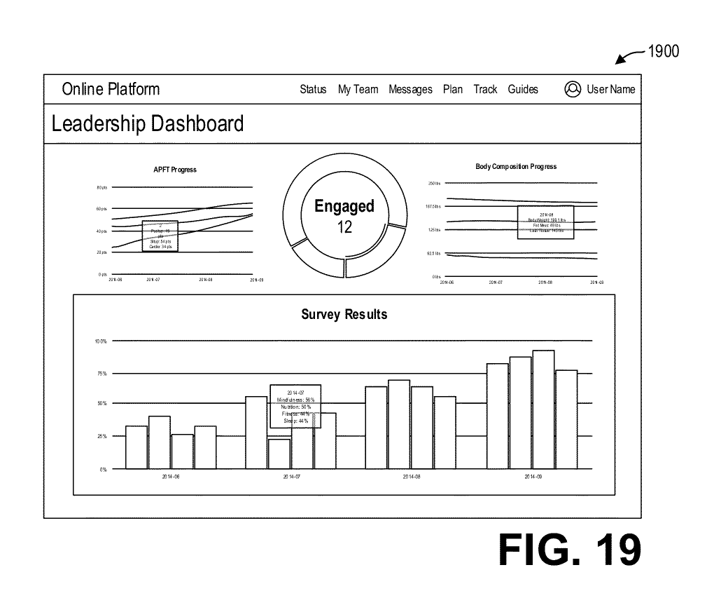

Dashboard contents displayed in interface 1800 are available in real-time and access is dictated by specific access levels assigned to each stakeholder. Further, aggregate survey and assessment response data are made available for long-term behavioral trend analysis. FIG. 19 shows an example interface 1900 for displaying aggregated qualitative metrics to show long-term health behavior modification and trends.

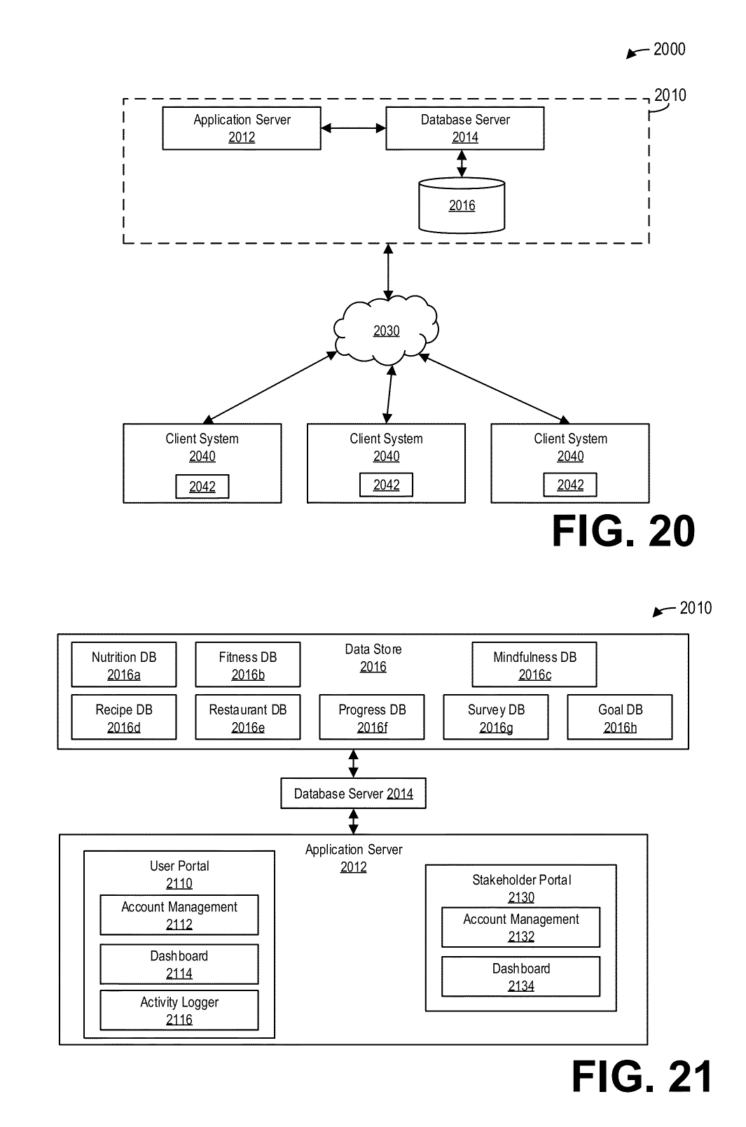

Referring now to FIG. 20, a schematic diagram illustrating an example network architecture for a behavioral fitness achievement system 2000 that can be configured to implement exemplary embodiments of the present invention, such as those described herein above, is provided. It should of course be understood that the behavioral fitness achievement system 2000 is intended as an example, not as an architectural limitation for different embodiments of the present invention, and therefore, the particular elements depicted in FIG. 20 should not be considered limiting with regard to the environments within which exemplary embodiments of the present invention may be implemented.

In the example illustrated in FIG. 20, behavioral fitness achievement system 2000 is implemented as a client/server system that includes a central server system 2010 that is commonly accessed by each user of the system through operation of any of a plurality of client systems 2040 that are operatively coupled to the central server system via a communication network 2030. Central server system 2010 further includes a database server 2014 that is coupled to a data store 2016 and an application server 2012, and each client system 2040 is a user terminal or other client device implementing software for running a respective client application 2042 for accessing services provided via a network-based application (also referred to herein as a network service) implemented by application server 2012. Such client applications may also be referred to as client modules, or simply clients, and may be implemented in a variety of ways. In exemplary embodiments, such client applications can be implemented as any of a myriad of suitable client application types, which range from proprietary client applications to web-based interfaces in which the application functionality is provided by a web server and/or a back-end program.

In exemplary embodiments, the behavioral fitness achievement system 2000 can include additional servers, clients, and other devices not shown in FIG. 20. The particular architecture depicted in FIG. 20 is provided as an example for illustrative purposes and, in exemplary embodiments, any number of client systems 2040 may be connected to server system 2010 at any given time via network 2030, and server system 2010 can comprise multiple server components and databases located within a single server system or within multiple server systems, where the multiple server systems are integrated with or accessible by users of client systems 2040 as a distributed server system via network 2030.

In exemplary embodiments, network 2030 can be configured to facilitate communications between server system 2010 and client systems 2040, as well as communications with and between other devices and computers connected together within the behavioral fitness achievement system 2000, by any suitable wired technology (including optical fiber), wireless technology, or any suitable combination thereof, including but not limited to personal area networks (PANs), local area networks (LANs), wireless networks, wide-area networks (WANs), the Internet (a network of heterogeneous networks using the Internet Protocol), and virtual private networks, and the network may also utilize any suitable hardware, software, and firmware technology to connect devices such as, for example, optical fiber, Ethernet, ISDN (Integrated Services Digital Network), T-1 or T-3 link, FDDI (Fiber Distributed Data Network), cable or wireless LMDS network, Wireless LAN, Wireless PAN (for example, IrDA, Bluetooth, Wireless USB, Z-Wave, Zig-Bee), HomePNA, power line communication, or telephone line network. Such a network connection can include intranets, extranets, and the Internet, may contain any number of network infrastructure elements including routers, switches, gateways, etc., can comprise a circuit switched network, such as the Public Service Telephone Network (PSTN), a packet switched network, such as the global Internet, a private WAN or LAN, a telecommunications network, a broadcast network, or a point-to-point network, and may utilize a variety of networking protocols now available or later developed including, but not limited to the Transmission Control Protocol/Internet Protocol (TCP/IP) suite of protocols for communication.

In exemplary embodiments, application server 2012, database server 2014, and any other servers employed within server system 2010 and third-party servers utilized within behavioral fitness achievement system 2000 can be implemented within any suitable computing system or systems such as a workstation computer, a mainframe computer, a server system, a server cluster, a distributed computing system, a cloud-based computing system, or the like, as well as any of the various types of computing systems and devices described herein. Server system 2010 may be implemented using any of a variety of architectures. For example, application server 2012 and database server 2014 may also be implemented independently or as a single, integrated device. While the exemplary embodiment illustrated in FIG. 20 depicts application server 2012 and database server 2014 as individual components, the applications provided by these servers, or various combinations of these applications, may actually be server applications running on separate physical devices. In this regard, server system 2010 may comprise a number of computers connected together via a network, and therefore, may exist as multiple separate logical and/or physical units, and/or as multiple servers acting in concert or independently, wherein each server may be comprised of multiple separate logical and/or physical units. In exemplary embodiments, server system 2010 can be connected to network 2030 through a collection of suitable security appliances, which may be implemented in hardware, software, or a combination thereof.

As illustrated in FIG. 20, application server 2012 is communicatively coupled to database server 2014. Database server 2014 is connected to data store 2016, which comprises a plurality of databases that are maintained by database server 2014, accessed by application server 2012 via database services provided at a front end by database server 2014, and store information on a variety of matters that is utilized in providing the services offered via the network service provided by the application server, as described herein. As used herein, the term “data store,” “data storage unit,” “storage device,” and the like can refer to any suitable memory device that may be used for storing data, including manual files, machine-readable files, and databases. In exemplary embodiments, application server 2012, database server 2014, and data store 2016 may be implemented together in a single computing device, implemented within a plurality of computing devices locally coupled to each other via a suitable communication medium, such as a serial port cable, telephone line or wireless frequency transceiver, implemented within a plurality of computing devices remotely coupled to each other via network 2030, or any suitable combination thereof.

Client systems 2040 are computer devices to which one or more users, which may be users of the network service as described herein above (including typical users and stakeholders). It should be noted that the term “user” is used herein to refer to one who uses a computer system, such as one of the client systems 2040. As described herein, client systems 2040 are each operable by such users to access server system 2010 via network 2030 and act as clients to access services offered by the network service provided by the server system within exemplary behavioral fitness achievement system 2000. For this purpose, each client system includes a respective client application 2042 that executes on the client system and allows a user to interact with server system 2010 via application server 2012.

In exemplary embodiments, the computer systems of client systems 2040 can be any of a wide range of suitable computing devices such as one or more workstations, desktop computers, laptops, or other personal computers (PCs), non-traditional computer systems such as personal digital assistants (PDAs) and other handheld or portable electronic devices, smart phones and other mobile handsets, tablet computers, netbook computers, game consoles, home theater PCs, desktop replacement computers, and the like, or any other suitable information processing devices.

In general, during operation of exemplary behavioral fitness achievement system 2000, a client system 2040 first establishes a connection to server system 2010 via network 2030. Once the connection is established, the connected client system may directly or indirectly transmit data to and access content from the application server 2012. A user accessing application server 2012 through the connected client system can use client application 2042 to access services provided by the application server, which are described in detail herein above, via a user interface implemented by the client application within which the client application renders the information served by the application server.

In exemplary embodiments, application server 2012 can implement the network service as a non-web client application (such as a mobile application), a web client application, or both to provide the services accessed by client systems 2040 within server system 2010, and client applications 2042 can correspondingly be implemented as non-web client applications, web client applications, or both for operation by users of the client systems to interact with application server 2012 and access the services provided thereby. For example, application server 2012 can comprise a web server configured to provide a web application for the respective client applications implemented on client systems 2040 that are configured to provide web-based user interfaces for utilizing the services provided by the web server. For instance, the user interfaces of client applications implemented on client systems 2040 can be configured to provide various options corresponding to the functionality offered in exemplary embodiments described herein through suitable user interface controls (for example, by way of menu selection, point-and-click, dialog box, or keyboard command). In one general example, the user interfaces may provide “send” or “submit” buttons that allow users of client applications to transmit requested information to application server 2012. The user interfaces can be implemented, for example, as a graphical user interface (GUI) that renders a common display structure to represent the network service provided by application server 2012 for a user of a client platform.

More specifically, in such an example, application server 2012 can, for example, be configured to provide services via a web-based software application hosting a corresponding website that includes a number of web pages (e.g., screens), and client applications 2042 can comprise a web browser executing on client systems 2040, such that the services provided by application server 2012 are accessible to client systems 2040 using the Internet or an intranet. Users of client systems 2040 may thereby access the website provided by application server 2012 by, for example, inputting or following a link to the uniform resource locator (URL) for the website in the web browser, which then enable users to display and interact with information, media, and other content embedded within the web pages of the website provided by application server 2012. The web-based software application can transmit information that can be processed by the web browsers to render a user interface using, for example, a browser-supported programming language such as JavaScript, HTML, HTML5, CSS, or the like, and can communicate with the web browsers using, for example, HTTPS, POST, and/or GET requests. Client applications 2042 and application server 2012 may be configured such that information transmitted between client systems 2040 and server system 2010 can be encrypted and sent over a secure network connection to protect privacy.

Referring now to FIG. 21, a block diagram illustrating an exemplary embodiment of server system 2010 is provided. As illustrated in FIG. 21, application server 2012 is implemented to provide a plurality of services via a user portal 2110 and a plurality of services via a stakeholder portal 2130. As described herein, application server 2012 can be implemented to provide a respective set of services for each of various types of users (for example, users, stakeholders), and some of the services offered by application server 2012 can be commonly applicable to and accessible by all types of users, while other services can be applicable to and accessible only by specific types of users. The services provided via user portal 2110 includes a registration and account management service 2112, a dashboard service 2114, and an activity logger 2116, while the services provided via stakeholder portal 2130 includes a registration and account management service 2132 and dashboard service 2134.

Data store 2016 comprises a plurality of databases that are maintained and accessible by application server 2012 via database server 2014, including a nutrition database 2016a (as described herein above with regard to FIG. 2), a fitness database 2016b (as described herein above with regard to FIG. 2), a mindfulness database 2016c (as described herein above with regard to FIG. 2), a recipe database 2016d (as described herein above with regard to FIGS. 15-16), a restaurant database 2016e (as described herein above with regard to FIGS. 8-7), a progress database 2016f (for storing user activity data regarding progress towards goals), a survey database 2016g (for storing user responses to qualitative surveys and assessments), and a health balance goal database 2016h (for storing health balance goals established by users and coaches). The data store 2016 may include additional databases not shown for storing any other suitable information that may be utilized by server system 2010 (for example, system usage data). In exemplary embodiments, the various databases maintained within data store 2016 can be maintained as groups within one or more larger databases or maintained individually.

Thus, in one embodiment, an apparatus for achieving and maintaining behavioral fitness comprises: a server providing a network service that is accessible to a plurality of users through a plurality of client systems communicatively coupled to the server via a network; and a data storage system storing a health balance goal database that is maintained by the server, the health balance goal database comprising a plurality of health balance goals established by the plurality of users, and wherein, upon being accessed by a user of one of the client systems, the network service is operable to receive an indication from the client system of a selected health balance goal selected from the plurality of health balance goals by the user, wherein, upon receiving the selection of the selected health balance goal from the client system, the network service is operable to issue a request for approval of the selected health balance goal by a coach via one of the client systems, and wherein the network service is operable to, upon receiving the approval from the coach: generate a meal plan, a workout plan, and a mindfulness plan based on the selected health balance goal, store the meal plan, the workout plan, and the mindfulness plan in the health balance goal database, receive data indicating one or more user activities related to one or more of the meal plan, the workout plan, and the mindfulness plan, store the received data within a progress database that is maintained within the data storage system by the server, and transmit a user interface to the client system for display to the user, the user interface generated based on the received data and visually depicting user progress towards meeting the health balance goal, the user progress based on the one or more user activities.

In a first example of the apparatus, the health balance goal comprises a combination of a fitness goal, mindfulness goal, and nutrition goal. In a second example of the apparatus optionally including the first example, the meal plan comprises a target B-count for each meal, wherein a B-count comprises a combination of caloric content and macronutrient content. In a third example of the apparatus optionally including one or more of the first and second examples, the network service is further operable to, responsive to receiving a restaurant query from the client device: detect a location of the user; calculate a current target B-count based on the meal plan and a time the restaurant query is received; retrieve at least one result from a restaurant database that is maintained within the data storage system by the server based on the location of the user and the current target B-count, wherein the at least one result comprises a restaurant and at least one menu item corresponding to the current target B-count; and transmit the at least one result to the client device. In a fourth example of the apparatus optionally including one or more of the first through third examples, the at least one result is displayed to the user via a map, wherein the map further indicates the location of the user. In a fifth example of the apparatus optionally including one or more of the first through third examples, the network service is further operable to: receive a list of one or more ingredients for a meal; calculate a B-count and a macronutrient balance of the meal based on the list of the one or more ingredients; and generate a user interface including a visual depiction of the macronutrient balance of the meal positioned adjacent to a visual depiction of an ideal macronutrient balance, and the calculated B-count. In a sixth example of the apparatus optionally including one or more of the first through fifth examples, receiving the data related to the one or more activities comprises receiving, from the user device, an image of a paper-based journal entry containing the data in a handwritten format, and automatically processing the image to extract the data from the image. In a seventh example of the apparatus optionally including one or more of the first through sixth examples, the user interface includes a form comprising a plurality of user inputs regarding sleep, the plurality of user inputs including a bed time, a wake-up time, and a sleep quality, and further comprising updating the user progress responsive to the user submitting the form and based on the plurality of user inputs. In an eighth example of the apparatus optionally including one or more of the first through seventh examples, the network service is further operable to adjust one or more of the meal plan, the fitness plan, and the mindfulness plan responsive to the user progress. In a ninth example of the apparatus optionally including one or more of the first through eighth examples, the user interface includes at least one graph visually comparing the user progress to progress of one or more other users.

In another representation, a method comprises: receiving, from a user via a user device, a health balance goal for the user; receiving, from a coach via a coach device, approval of the health balance goal; automatically generating a meal plan, a workout plan, and a mindfulness plan based on the health balance goal; receiving, from the user via the user device, data indicating one or more user activities related to one or more of the meal plan, the workout plan, and the mindfulness plan; and automatically generating a user interface for display via one or more of the user device and the coach device, the user interface visually depicting user progress towards meeting the health balance goal, the user progress based on the one or more user activities.

In a first example of the method, the health balance goal comprises a combination of a fitness goal, mindfulness goal, and nutrition goal. In a second example of the method optionally including the first example, the meal plan comprises a target B-count for each meal, wherein a B-count comprises a combination of caloric content and macronutrient content. In a third example of the method optionally including one or more of the first and the second examples, the method further comprises, responsive to receiving a restaurant query from the user device: detecting a location of the user; calculating a current target B-count based on the meal plan and a time the restaurant query is received; retrieving at least one result based on the location of the user and the current target B-count, wherein the at least one result comprises a restaurant and at least one menu item corresponding to the current target B-count; and transmitting the at least one result to the user device. In a fourth example of the method optionally including one or more of the first through third examples, the method further comprises displaying the at least one result on a map, wherein the map further indicates the location of the user. In a fifth example of the method optionally including one or more of the first through fourth examples, the method further comprises: receiving a list of one or more ingredients for a meal; calculating a B-count and a macronutrient balance of the meal based on the list of the one or more ingredients; and automatically generating a user interface including a visual depiction of the macronutrient balance of the meal positioned adjacent to a visual depiction of an ideal macronutrient balance, and the calculated B-count. In a sixth example of the method optionally including one or more of the first through fifth examples, receiving the data regarding the one or more activities comprises receiving, from the user device, an image of a paper-based journal entry containing the data in a handwritten format, and automatically processing the image to extract the data from the image. In a seventh example of the method optionally including one or more of the first through sixth examples, the user interface includes a form comprising a plurality of user inputs regarding sleep, the plurality of user inputs including a bed time, a wake-up time, and a sleep quality, and further comprising updating the user progress responsive to the user submitting the form and based on the plurality of user inputs. In an eighth example of the method optionally including one or more of the first through seventh examples, the method further comprises adjusting one or more of the meal plan, the fitness plan, and the mindfulness plan responsive to the user progress. In a ninth example of the method optionally including one or more of the first through eighth examples, the user interface includes at least one graph visually comparing the user progress to progress of one or more other users.

In another embodiment, a computer-generated interface for display to a user on a user device comprises: a visual overview of individual progress of the user with regard to nutrition goals and fitness goals; a graph visually depicting the individual progress of the user in comparison to other users; one or more resilience principles and a personal motivation input by the user; and an activity log displaying recently logged progress for the user and the other users.

In a first example of the interface, the interface further comprises a plurality of user inputs for logging progress towards the nutrition goals and the fitness goals. In a second example of the interface optionally including the first example, the plurality of user inputs for logging progress towards the nutrition goals comprises one or more user inputs for selecting a recipe from a list of recipes retrieved from a repository, wherein the repository further includes data regarding caloric content and macronutrient content for each meal. In a third example of the interface optionally including one or more of the first and second examples, the nutrition goals and the fitness goals are established based on the user and a coach of the user. In a fourth example of the interface optionally including one or more of the first through third examples, the personal motivation comprises an image uploaded by the user.

In yet another embodiment, a computer-readable storage medium includes executable instructions stored thereon, the executable instructions configured to cause a computer to: automatically assign a category to each user of a plurality of users based on quantitative and qualitative data; aggregate the quantitative and qualitative data received from the plurality of users; generate a user interface based on the aggregated quantitative and qualitative data, including a graph illustrating a number of users in the plurality of users assigned to each category; and transmit the user interface to a computing device for display to a stakeholder.

In a first example of the computer-readable storage medium, the aggregated quantitative and qualitative data comprises survey results received from the plurality of users, and wherein the user interface includes a graph comparing the survey results over time. In a second example of the computer-readable storage medium optionally including the first example, the user interface further includes a graph illustrating aggregated fitness test results over time. In a third example of the computer-readable storage medium optionally including one or more of the first and the second examples, the user interface further includes a graph illustrating body composition progress over time, wherein the body composition progress comprises data regarding body weight, fat mass, and lean tissue mass. In a fourth example of the computer-readable storage medium optionally including one or more of the first through third examples, the user interface further includes an overview of goals and progress towards the goals for individual users in the plurality of users based on the category assigned to the individual users.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

1. An apparatus, comprising:
a server providing a network service that is accessible to a plurality of users through a plurality of client systems communicatively coupled to the server via a network; and
a data storage system storing a health balance goal database that is maintained by the server, the health balance goal database comprising a plurality of health balance goals established by the plurality of users, and
wherein, upon being accessed by a user of one of the client systems, the network service is operable to receive an indication from the client system of a selected health balance goal selected from the plurality of health balance goals by the user,
wherein, upon receiving the selection of the selected health balance goal from the client system, the network service is operable to issue a request for approval of the selected health balance goal by a coach via one of the client systems, and
wherein the network service is operable to, upon receiving the approval from the coach:
generate a meal plan, a workout plan, and a mindfulness plan based on the selected health balance goal,
store the meal plan, the workout plan, and the mindfulness plan in the health balance goal database,
receive data indicating one or more user activities related to one or more of the meal plan, the workout plan, and the mindfulness plan,
store the received data within a progress database that is maintained within the data storage system by the server, and
transmit a user interface to the client system for display to the user, the user interface generated based on the received data and visually depicting user progress towards meeting the health balance goal, the user progress based on the one or more user activities.

2. The apparatus of claim 1, wherein the health balance goal comprises a combination of a fitness goal, mindfulness goal, and nutrition goal.

3. The apparatus of claim 1, wherein the meal plan comprises a target B-count for each meal, wherein a B-count comprises a combination of caloric content and macronutrient content.

4. The apparatus of claim 3, wherein the network service is further operable to, responsive to receiving a restaurant query from the client device:
detect a location of the user;
calculate a current target B-count based on the meal plan and a time the restaurant query is received;
retrieve at least one result from a restaurant database that is maintained within the data storage system by the server based on the location of the user and the current target B-count, wherein the at least one result comprises a restaurant and at least one menu item corresponding to the current target B-count; and
transmit the at least one result to the client device.

5. The apparatus of claim 4, wherein the at least one result is displayed to the user via a map, wherein the map further indicates the location of the user.

6. The apparatus of claim 3, wherein the network service is further operable to:
receive a list of one or more ingredients for a meal;
calculate a B-count and a macronutrient balance of the meal based on the list of the one or more ingredients; and
generate a user interface including a visual depiction of the macronutrient balance of the meal positioned adjacent to a visual depiction of an ideal macronutrient balance, and the calculated B-count.

7. The apparatus of claim 1, wherein receiving the data related to the one or more activities comprises receiving, from the user device, an image of a paper-based journal entry containing the data in a handwritten format, and automatically processing the image to extract the data from the image.

8. The apparatus of claim 1, wherein the user interface includes a form comprising a plurality of user inputs regarding sleep, the plurality of user inputs including a bed time, a wake-up time, and a sleep quality, and further comprising updating the user progress responsive to the user submitting the form and based on the plurality of user inputs.

9. The apparatus of claim 1, wherein the network service is further operable to adjust one or more of the meal plan, the fitness plan, and the mindfulness plan responsive to the user progress.

10. The apparatus of claim 1, wherein the user interface includes at least one graph visually comparing the user progress to progress of one or more other users.

11. A computer-generated interface for display to a user on a user device, the interface comprising:
a visual overview of individual progress of the user with regard to nutrition goals and fitness goals;
a graph visually depicting the individual progress of the user in comparison to other users;
one or more resilience principles and a personal motivation input by the user; and
an activity log displaying recently logged progress for the user and the other users.

12. The interface of claim 11, further comprising a plurality of user inputs for logging progress towards the nutrition goals and the fitness goals.

13. The interface of claim 12, wherein the plurality of user inputs for logging progress towards the nutrition goals comprises one or more user inputs for selecting a recipe from a list of recipes retrieved from a repository, wherein the repository further includes data regarding caloric content and macronutrient content for each meal.

14. The interface of claim 11, wherein the nutrition goals and the fitness goals are established based on the user and a coach of the user.

15. The interface of claim 11, wherein the personal motivation comprises an image uploaded by the user.

16. A computer-readable storage medium including executable instructions stored thereon, the executable instructions configured to cause a computer to:
automatically assign a category to each user of a plurality of users based on quantitative and qualitative data;
aggregate the quantitative and qualitative data received from the plurality of users;
generate a user interface based on the aggregated quantitative and qualitative data, including a graph illustrating a number of users in the plurality of users assigned to each category; and
transmit the user interface to a computing device for display to a stakeholder.

17. The computer-readable storage medium of claim 16, wherein the aggregated quantitative and qualitative data comprises survey results received from the plurality of users, and wherein the user interface includes a graph comparing the survey results over time.

18. The computer-readable storage medium of claim 16, wherein the user interface further includes a graph illustrating aggregated fitness test results over time.

19. The computer-readable storage medium of claim 16, wherein the user interface further includes a graph illustrating body composition progress over time, wherein the body composition progress comprises data regarding body weight, fat mass, and lean tissue mass.

20. The computer-readable storage medium of claim 16, wherein the user interface further includes an overview of goals and progress towards the goals for individual users in the plurality of users based on the category assigned to the individual users.
